(19) United States
(12) Patent Application Publication
(10) Pub. No.: US 2025/0253549 A1
(43) Pub. Date: Aug. 7, 2025

(54) Antenna For Telematics Control Unit

(71) Applicant: Joynext GmbH, Dresden (DE)

(72) Inventors: Tom Pickenhan, Dresden (DE); Christian Stopp, Dresden (DE); Norbert Martsch, Dresden (DE); Michael Metko, Dresden (DE)

(21) Appl. No.: 18/986,929

(22) Filed: Dec. 19, 2024

(30) Foreign Application Priority Data
Feb. 7, 2024 (DE) 202024100598U1

(51) Int. Cl. H01Q 21/28; H01Q 1/24; H01Q 1/42

(52) U.S. Cl. CPC H01Q 21/28; H01Q 1/241; H01Q 1/421

(57) ABSTRACT

The invention relates to a telematics control unit (100) with a housing (102), a printed circuit board (101) and at least one antenna (103, 104) for GNSS signals arranged outside the housing. T at least one antenna for signal transmission has an outer conductor and an inner conductor (105) with a dielectric sheathing (107). The inner conductor is arranged eccentrically in a dielectric sheathing, and the inner conductor and the dielectric sheathing extend through an opening of the housing (102) and the inner conductor is electrically connected to the printed circuit board (101).

The invention relates to a telematics control unit with a housing. Such a device can be used in motor vehicles, for example, to enable radio connections of the motor vehicle by means of various radio standards.

Modern motor vehicles are equipped with a variety of networking technologies. These enable the connectivity of the vehicle with the outside world, e.g. via mobile communications (e.g. 3G, 4G or 5G) or so-called V2X (Vehicle-To-X) radio technologies. The vehicle can be positioned using satellite-based positioning systems, e.g. GPS (Global Positioning System). A telematics control unit acts as a central connectivity gateway.

### BACKGROUND

Antenna units for vehicles and vehicles with antenna units are already known from the state of the art. For example, EP 2317603 A1 describes a multi-standard antenna module for traffic telematics systems in which several individual antennas are arranged in an antenna housing.

Known telematics control units have antennas that are arranged outside a shielding housing. The antenna is contacted through an opening in the housing wall by means of a connector. The connector can be a molded part or a short RF cable. In either case, the connector requires an additional electrical connection, which can be a soldered, crimped or plug-in connection. An additional connection not only requires additional assembly work but, like any electrical connection, also impairs the reliability of the overall system, in this case the telematics control unit.

### SUMMARY

It is a task of the present disclosure to simplify the structure of a telematics control unit. The simplification leads to lower manufacturing costs and higher reliability for the control unit.

This problem is solved for a control unit with an antenna with the features of independent claim 1. Embodiments for a control unit with two antennas are also described in the claims. Two antennas are arranged one above the other, or two antennas are arranged side by side for a control unit. Further advantageous embodiments are contained in the subordinate claims and the following description in conjunction with the figures.

According to claim 1 and following claims, a telematics control unit with a housing is proposed. The housing is formed from metal or plastic with a conductive surface for reasons of shielding.

The telematics control unit comprises a first circuit board inside the housing, on which an electronic control unit is arranged. This control unit processes signals from satellite-based positioning systems of the GNSS (Global Navigation Satellite Systems). These signals come from an antenna that is arranged on the outside of the housing of the control unit. For example, the antenna is glued to the housing by means of an adhesive layer and/or attached to the housing with a latching mechanism.

The antenna has an electrical connection with an inner conductor and an outer conductor. The outer conductor is electrically connected to the housing of the telematics control unit. The inner conductor is electrically insulated from the outer conductor by means of a dielectric coating and has a defined characteristic impedance, for example 50 ohms. The dielectric sheathing has a low-loss dielectric material, for example polymers such as Teflon® (PTFE), polyethylene (PE), polystyrene (PS), acrylonitrile-butadiene-styrene copolymer (ABS), polyamide (PA) or ceramic material or one of the aforementioned polymers with ceramic fillers.

The inner conductor and the dielectric sheathing are fed through an opening in the housing wall into the interior of the control unit. Preferably, the housing wall is shaped inwards at the edge of the opening and forms the outer conductor.

The molded housing wall is connected to the printed circuit board of the control unit via a flexible contact element. The flexible contact element is arranged on the printed circuit board and can be a spring contact, an elastic polymer pad with a conductive surface or an elastic pad made of a conductive polymer.

The inner conductor is electrically contacted on the printed circuit board of the control unit by means of a plug connection. The inner conductor forms part of the plug connection. The other part of the plug connection is located on the printed circuit board and can be secured against unintentional disconnection with a contact spring tongue.

### BRIEF DESCRIPTION OF THE DRAWINGS

FIG. 1 shows a lateral cross-section with two antennas (103, 104) arranged one above the other on the housing (102) of a telematics control unit (100).

FIGS. 2a-2c show views of the openings in the housing of the control unit with the inner conductors (105, 106), which are each enclosed by a dielectric sheathing (107, 108). The inner conductors run eccentrically in the dielectric sheathing.

### DESCRIPTION OF EXAMPLE EMBODIMENTS

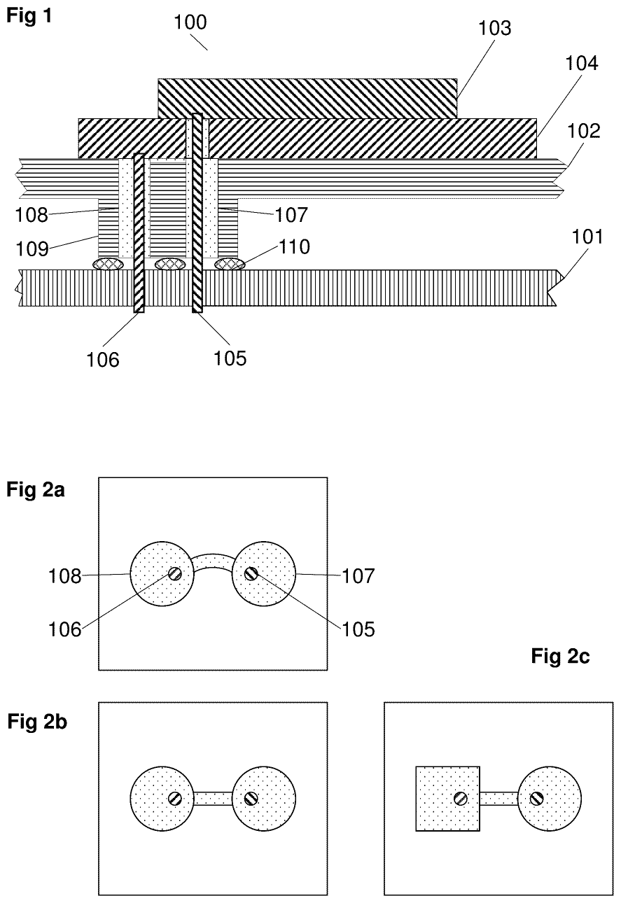

FIG. 1 shows a lateral cross-section with two antennas (103, 104) arranged one above the other on the housing (102) of a telematics control unit (100).

Each antenna has an inner conductor (105, 106) with a dielectric coating (107, 108). The inner conductors with sheathing are each led through an opening into the interior of the housing. The inner conductors lead without interruption and without extension to a circuit board (101) in the control unit, where they are electrically connected to the circuit board.

The outer conductors of the antennas are formed by metallic areas of the antenna bodies. By arranging the antenna bodies directly on top of each other and on the metallic housing of the control unit, the outer conductor is transferred to the housing. At the edge of the housing openings, the housing wall is formed inwards (109) and extends to the circuit board inside the control unit. The molded housing wall encloses the dielectric sheathing of the inner conductor and forms the common outer conductor. Flexible contact elements (110) are arranged on the printed circuit board, which electrically connect the outer conductor to the printed circuit board.

FIGS. 2a-2c show views of the openings in the housing of the control unit with the inner conductors (105, 106), which are each enclosed by a dielectric sheathing (107, 108). The inner conductors run eccentrically in the dielectric sheathing.

FIG. 2b shows the basic form, FIGS. 2a and 2c show exemplary designs with position securing, which only allows the two antennas to be placed in a predetermined position and thus prevents the two inner conductors from being connected in reverse. The position securing can be achieved formed by a formed connection between the two dielectric sheathings (FIG. 2a) or by different outer contours of the dielectric sheathings (FIG. 2c). Both variants require a corresponding design of the housing openings.

### LIST OF REFERENCE NUMBERS

100 Control unit
101 Printed circuit board
102 Housing
103, 104 Antenna
105, 106 Inner conductor
107, 108 Dielectric sheathing
109 Molded housing wall
110 Flexible contact element

What is claimed is:

1. Telematics control unit with a printed circuit board, a housing, and an antenna for GNSS signals arranged outside the housing, wherein the antenna has an outer conductor and an inner conductor with a dielectric sheathing for signal transmission, and wherein the inner conductor and the dielectric sheathing extend through an opening of the housing and the inner conductor is electrically connected to the printed circuit board.

2. Telematics control unit with a printed circuit board, a housing and two antennas for GNSS signals arranged one above the other outside the housing, wherein the two antennas have a common outer conductor and two inner conductors enclosed by dielectric sheathing, wherein the two inner conductors and the dielectric sheathing extend through an opening in the housing and the two inner conductors are electrically connected to the printed circuit board.

3. Telematics control according to claim 2, wherein the two inner conductors are enclosed by common dielectric sheathing, and the inner conductors with the common dielectric sheathing extending through an opening in the housing and being electrically connected to the printed circuit board.

4. Telematics control unit having a printed circuit board, a housing and two antennas for GNSS signals arranged outside the housing, the two antennas having an outer conductor and an inner conductor with a dielectric sheathing each, and the two inner conductors extending with their dielectric sheathing through an opening in the housing and the two inner conductors being electrically connected to the printed circuit board.

5. Telematics control unit according to claim 1, wherein an inner conductor is arranged eccentrically in the dielectric sheathing.

6. Telematics control unit according to claim 1, wherein an antenna is fixed to the outside of the housing with an adhesive layer.

7. Telematics control unit according to claim 1, wherein the printed circuit board has at least one metallic spring contact element and an inner conductor is electrically connected to the metallic spring contact element.

8. Telematics control unit according to claim 1, wherein the housing wall is molded inwardly at the opening and the inwardly molded housing wall forms a part of the outer conductor of an antenna.

9. Telematics control unit according to claim 1, wherein the printed circuit board has a flexible contact element and the inwardly molded housing wall is electrically connected to the flexible contact element.

10. Telematics control unit according to claim 1, wherein the flexible contact element comprises a metallic spring contact, an elastic conductive polymer or an elastic metallized polymer.

11. Telematics control unit according to claim 1, wherein the dielectric sheathing of an antenna and an opening in the housing wall are provided form-fit such that the antenna can only be arranged in a predetermined position on the housing of the telematics control unit.
